(19) United States
(12) Patent Application Publication
(10) Pub. No.: US 2012/0230769 A1
(43) Pub. Date: Sep. 13, 2012

(54) SYSTEM AND METHOD FOR DESTROYING GROUND PEARL

(76) Inventor: Mark R. Holmes, Wilmington, NC (US)

(21) Appl. No.: 13/413,950

(22) Filed: Mar. 7, 2012

Related U.S. Application Data
(60) Provisional application No. 61/464,724, filed on Mar. 8, 2011.

(51) Int. Cl. B09C 1/06

(52) U.S. Cl. 405/128.85

(57) ABSTRACT

A method and apparatus is described for treating ground pearl in infested soil. An apparatus including a plurality of vertically oriented probes having steam outlets in communication with a common source of steam is provided. The probes are arrayed in a plurality of parallel rows with each row including a plurality of probes. The probes are inserted into the soil to a depth of at least 12 inches, and steam is injected through the probes and out of the steam outlets to contact the ground pearl, where all of the soil between said probes is heated to a temperature at least sufficient to kill ground pearl. In a preferred embodiment, the apparatus includes a means for injecting high pressure water or other penetrating fluid into the soil beneath the probes to form holes into which the probes are inserted.

This application claims the benefit of the filing date of U.S. Provisional Patent Application No. 61/464,724, filed Mar. 8, 2011, which is incorporated herein in its entirety.

### BACKGROUND OF THE INVENTION

(1) Field of the Invention

The present invention relates generally to an improved system and method for destroying ground pearl, and in particular to the destruction of ground pearl using pressurized steam injected into the soil with a unique applicator apparatus.

(2) Description of the Prior Art

Ground pearls are members of a unique family of scale insects, Order Hemiptera, Family Margarodidae, for which there is no known effective control. Ground pearls live in the soil. During their pre-adult stage, the insect has no means of mobility and is enclosed in a lustrous cyst, thus the name ground pearl.

During this stage, a hair-like mouth part extends from the cyst and is used to suck plant juices from the roots of a wide range of warm-season turfgrasses, including Bermuda grass, centipede grass, St. Augustine grass and zoysia grass, thereby killing the grass. Ground pearls are hardy insects that live as deep as twelve inches in the soil and can tolerate unfavorable conditions for an extended period of time.

Insecticides and nematicides, and other conventional means of insect control, are not effective in controlling ground pearl. Removal and replacement of topsoil is also ineffective due to the depth of the ground pearl. Due to the considerable damage caused by ground pearl to turf grasses, particularly in the Southeast, there is a great need for a means of destroying ground pearl.

### SUMMARY OF THE INVENTION

The present invention addresses this need by providing a method and apparatus for destroying ground pearl by injecting steam at a depth of up to twelve inches beneath the surface of ground pearl infected soil. It has been found that this treatment performed in accordance with the present invention effectively destroys ground pearl in the treatment area.

Generally, the preferred apparatus of the present invention is comprised of an array of spaced probes in communication with a soil penetration fluid, which may be water or air, and a source of steam. Each probe is comprised of an inner tubular conduit for projecting the penetration fluid downwardly against the soil to displace soil, creating a bore into the soil, and an outer tubular conduit for injecting steam radially outward from the probe after the probe has been inserted into a bore. In the preferred embodiment described herein, the conduits are coaxial, with the steam conduit surrounding the penetration fluid conduit.

The penetration fluid conduits of the array include upper proximal ends that are in communication with a source of pressurized fluid, i.e., water or air. If water is used as the penetration fluid, the water may be unheated or heated. The outer or steam conduit is in communication with a source of pressurized steam.

In a preferred embodiment of the invention, the probes are spaced equidistant from each other in an array with the upper proximal ends of the outer steam conduits being in communication with horizontal, interconnected, tubular connector conduits. The connector conduits may comprise, for example, a plurality of parallel, spaced conduits that are in communication with each other by way of transverse end conduits joining the ends of the parallel conduits. Each of the parallel conduits is in communication with a plurality of downwardly extending probe outer conduits. Probe inner conduits extend upward through the outer conduits and within the connector conduits.

The probe outer conduits communicate with a source of penetration fluid, e.g., a tank of pressurized air or a source of pressurized water, which may be heated. For example, a fitting adapted to connection to a hose extending from the penetration fluid source may be attached to an end of inner conduit so that fluid from the source will flow through the fitting and the connector conduits to the probe penetration conduits. Similarly, a steam fitting is attached to one of the connector conduits so that steam from a steam source will flow through the steam fitting and the connector conduits to the probe outer steam conduits. Each conduit includes a shutoff valve to control the flow through the conduit.

Each probe outer conduit includes a plurality of steam discharge openings in the wall of the probe outer conduit, e.g., the discharge openings may be small circular openings through which steam is radially discharged from the probe. The openings are preferably spaced around the probe so that steam is discharged to all sides of the probe. The space between the distal end of the outer conduit and the inner penetration conduit is preferably sealed, e.g., by a downwardly tapered sleeve having an upper end attached, to the end of the outer conduit and an inner end attached to the penetration conduit, so that steam is not discharged between the two conduits. The distal end of the inner penetrating conduit extends slightly beyond the outer conduit, and includes an opening for the downward discharge of pressurized water or air.

In operation, the apparatus of the present invention is placed on the surface of the soil to be treated, with the tips of the probes resting against the soil. The apparatus is connected to a source of pressurized air or water, and to a source of pressurized steam. The valve to the inner penetration fluid conduits is opened first, causing high pressure air or water to exit downwardly from the probe tips and against the soil surface. Since the soil in areas most prone to ground pearl tends to be somewhat frangible, often with a high sand content, the soil is displaced by the pressure of the penetrating fluid, creating a hole or bore beneath each probe. As the holes are dug by the penetrating fluid, the apparatus is lowered, with the probes being inserted into the holes.

After the probes are fully inserted, e.g., up to about 12 inches, the valve to the penetrating fluid is closed and the valve to the steam supply is opened, causing steam to flow through the outer conduits for discharge through the opening in the probe outer conduit wall. The steam penetrates to soil around each probe, rapidly heating the soil to a temperature sufficient to kill the ground pearl. The spacing between the probes and the pressure of the steam is such that all of the soil between the probes is heated to a temperature that will kill the ground pearl.

In a simplified, more economical, alternative embodiment of the apparatus, the penetration fluid conduits and source are omitted. Instead, the soil is initially loosened with a spade or other tool, and the probes are manually pushed into the soil to the desired depth. The operation of the method and the above limitations as related to the probes are otherwise the same as in the preferred embodiment.

It is also within the scope of, the invention to add one or more insecticides to the penetrating fluid or to the steam so that the insecticide penetrates the soil along with the steam.

It is known to use a steam probe to kill ground insects such as fire ants. However, it has not heretofore been appreciated that steam could be used to kill ground pearl. In addition, the prior art is directed to insertion of a single probe into an ant hill, whereas the present invention is directed to insertion of a multiplicity of probes into the soil in an array, so that a relatively large area of soil is treated, ground pearl over the area and preventing spreading from adjacent areas after treatment.

### BRIEF DESCRIPTION OF THE DRAWINGS

FIG. 1 is a perspective top view of a preferred apparatus of the invention.

FIG. 2 is a side view of a preferred apparatus of the invention attached to a penetration liquid source and a pressurized steam source.

FIG. 3 is a sectional side view of the lower end of a probe.

FIG. 4 is a sectional side view of fluid and steam conduits.

FIG. 5 is a perspective top view of an alternative apparatus of the invention.

FIG. 6 is a side view of the alternative apparatus of the invention attached to a pressurized steam source.

FIG. 7 is a sectional side view of the lower end of a probe of the alternative apparatus.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

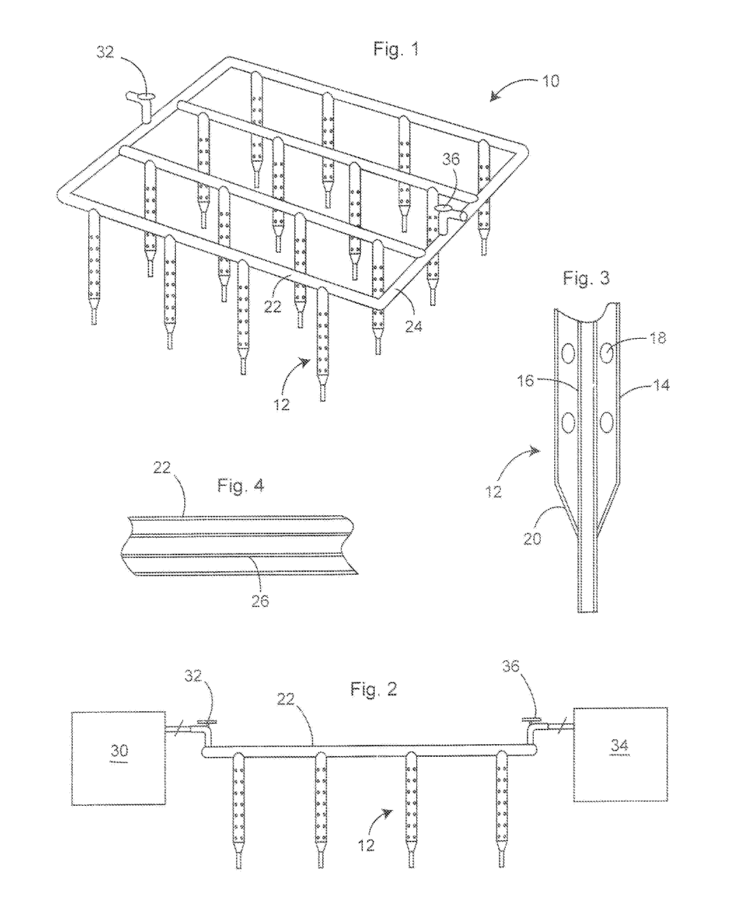

As seen in FIGS. 1-4 of the drawings, a preferred apparatus, generally 10, is comprised of an array of downwardly extending probes, generally 12. Preferably, probes 12 are arrayed in a rectangular pattern formed of parallel rows of probes spaced equidistant from each other at a given distance, with the spacing of the rows also being at the given distance. Apparatus 10, as illustrated, includes sixteen probes. Preferably, the array includes at least four spaced rows of probes, with each row including at least four spaced probes.

It will be understood from a reading of the present description, however, that a larger or smaller number of probes may be used depending on the area to be treated at one time. For example, arrays may be constructed with as few as 2 or as many as 150 probes. The given distance will depend on factors such as the nature of the soil to be normally treated and the pressure of the steam. However, spacing between the probes of 2 to 12 inches may normally be used.

Each probe 12, as best illustrated in FIG. 3, is comprised of an outer probe conduit 14 and a coaxial inner probe conduit 16. Probe conduit 14 includes a plurality of holes 18 for radial discharge of steam. A conical member 20 closes the lower end of conduit 14 so that steam does not escape between the lower ends of the conduits. Preferably, outer steam conduit 14 has a diameter of from about ½ inch to about 2 inches, while the diameter of inner penetration fluid conduit 16 is from about 1/32 inch to about ¼ inch. The lengths of probes 12 will generally be from about 6 inches to about 6 feet.

The upper ends of each probe conduit 14 in a row communicate with an outer conduit 22. The ends of conduits 22 communicate with transverse end conduits 24 forming a closed loop so that steam will flow through conduits 24 and 22 and downwardly through conduits 14 for discharge through holes 18. Inner probe conduits 16 extend upwardly through Outer conduits 14 to communicate with penetration fluid conduits 26 within conduits 22 and 24 as noted, for example, in FIG. 4.

Steam conduits 14, 22 and 24 communicate with a steam, source 30 from which pressurized steam is introduced into the conduits. Valve 32 controls the introduction of steam. Penetration fluid, either water or air, enters fluid conduits 26 and 16 from fluid source 34 with flow controlled via valve 36.

In operation, apparatus 10 is placed on the surface of the soil to be treated, with the tips of probes 12 resting on the soil. Penetration fluid is then directed from fluid source 34 through probe inner conduits 16 by opening valve 36. Discharge of the pressurized water or air downwardly from probes 12 creates bores in the soil, with apparatus 10 being lowered as the bores are dug into the soil, with probes 12 being inserted into the bores.

When probes 12 are fully inserted, valve 36 is closed, and, valve 32 is opened, whereby pressurized steam from source 30 is conveyed through conduits 22, 24 and 14 for radial discharge through holes 18 into the soil. The discharged steam heats the soil surrounding the probes to a temperature sufficient to kill the ground pearl. The overlapping areas of steam discharge due to the array of probes 12, heats all of the soil beneath apparatus 10. After the soil is heated to the desired temperature, valve 32 is closed and apparatus 10 can be moved to another location.

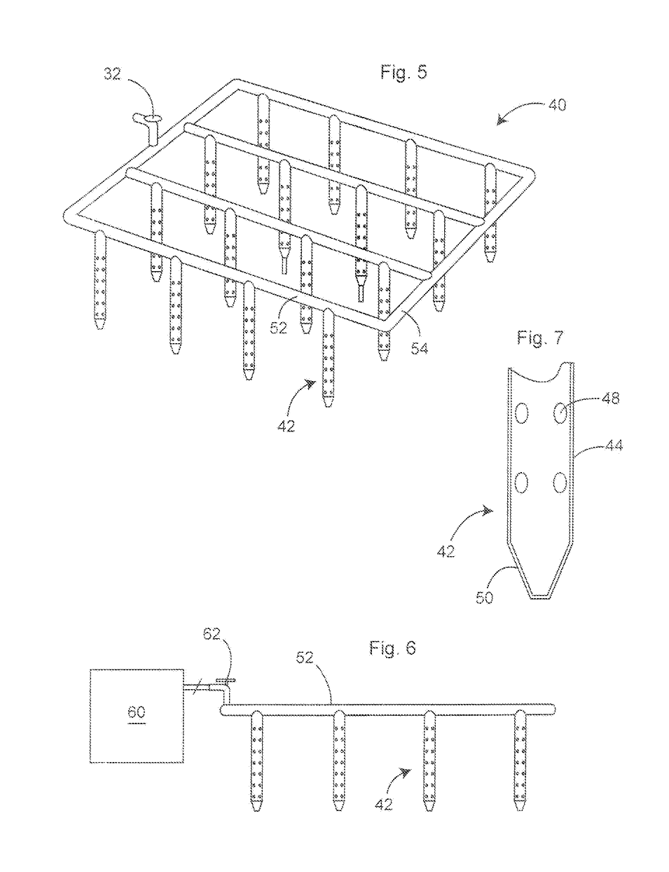

FIGS. 5-7 describe a simpler alternative apparatus, generally 40, which uses only steam. Instead of using high pressure water or air to insert the probes, the soil is first loosened and the probes are manually pushed into the soil to the desired depth.

Apparatus 40 is comprised of an array of downwardly extending probes, generally 42 arrayed in a rectangular pattern formed of parallel rows of probes spaced equidistant from each other at a given distance, with the spacing of the rows also being at the given distance. Apparatus 40, as illustrated, includes sixteen probes. As in the case of the preferred apparatus illustrated in FIGS. 1-4, a larger or smaller number of probes, e.g., from 4 or as many as 150 probes, may be used, with spacing between the probes being normally 2 to 12 inches.

Each probe 42, as best illustrated in FIG. 7, is comprised of a probe conduit 44 that includes a plurality of holes 48 for radial discharge of steam. A conical member 50 closes the lower end of conduit 44 so that steam does not escape between the lower ends of the conduits. Preferably, conduit 44 has a diameter of from about ½ inch to about 2 inches. The lengths of probes 12 will generally be from about 6 inches to about 6 feet. Preferably, the probes are 12 to 24 inches in length, since probes of at least 12 inches in length are normally required to ensure steam contact with the ground pearl.

The upper ends of each probe conduit 44 in a row communicate with an outer conduit 52. The ends of conduits 52 communicate with transverse end conduits 54 forming a closed loop so that steam will flow through conduits 54 and 52 and downwardly through conduits 44 for discharge through holes 48. Conduits 54, 52 and 44 communicate with a steam source 60 from which pressurized steam is introduced into the conduits. Valve 62 controls the introduction of steam.

In using the alternative apparatus, the ground pearl infested soil is first loosened with a spade or by other means to enable insertion of probes 44 into the soil. Apparatus 40 is placed on the surface of the soil to be treated, and pushed downwardly so that probes 44 are fully inserted. Valve 62 is then opened, whereby pressurized steam from source 60 is conveyed through conduits 52, 54 and 44 for radial discharge through holes 48 into the soil.

The discharged steam heats the soil surrounding the probes to a temperature sufficient to kill the ground pearl. The overlapping areas of steam discharge due to the array of probes 44, heats all of the soil beneath apparatus 40. After the soil is heated to the desired temperature, valve 62 is closed and apparatus 40 can be moved to another location.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A method of treating ground pearl in infested soil comprising:
a) providing a plurality of probes having steam outlets in communication with a source of steam;
b) inserting said probes into the soil; and
c) injecting steam through said probes and out of said steam outlets to contact said ground pearl.

2. The method of claim 1, wherein said probes are arranged in a plurality of spaced rows.

3. The method of claim 1, wherein said probes are inserted into said soil at a depth of at least 12 inches.

4. The method of claim 1, wherein said steam is discharged radially from said probes.

5. The method of claim 1, wherein an insecticide is discharged with said steam.

6. The method of claim 1, wherein said probes are spaced at a distance from adjacent probes so that the steam heats the soil in overlapping patterns.

7. The method of claim 1, further including creating a plurality of holes beneath said probes using pressurized fluid, and inserting said probes into said holes.

8. A method of treating ground pearl in infested soil comprising:
a) providing an apparatus comprised of a plurality of probes having steam outlets in communication with a common source of steam, said probes being arrayed in a plurality of parallel rows, each row including a plurality of probes;
b) inserting said probes into the soil to a depth of at least 12 inches; and
c) injecting steam through said probes and out of said steam outlets to contact said ground pearl, where all of the soil between said probes is heated to a temperature sufficient to kill ground pearl.

9. The method of claim 8, wherein said steam is discharged radially from said probes.

10. The method of claim 8, wherein an insecticide is discharged with said steam.

11. The method of claim 8, wherein said probes are spaced at a distance from each other of from about 2 inches to about 12 inches.

12. The method of claim 8, further including creating a plurality of holes beneath said probes using pressurized fluid, and inserting said probes into said holes.

13. An apparatus for treating ground pearl in infested soil comprising:
a) a plurality of rows of spaced vertically oriented probes including steam outlets;
b) horizontal conduits connecting said probes; and
c) a steam source connected to said horizontal conduits to direct steam to said probes.

14. The apparatus of claim 13, further including vertical pressurized fluid conduits having distal ends within said probes, horizontal fluid conduits connecting said vertical fluid conduits, and a source of pressurized fluid connected to said horizontal fluid conduits to direct water through said horizontal and vertical fluid conduits and out of the distal end of said vertical fluid conduits.

15. The apparatus of claim 13, wherein said probes are at least 12 inches in length and are separated relative to adjacent probes so that the steam array from adjacent probes overlap.

16. The apparatus of claim 13, wherein said steam outlets are radially oriented.

17. The apparatus of claim 13, wherein said probes arranged in a rectangular array.

18. The apparatus of claim 17, wherein said array is comprised of at least four rows of probes, each of said rows including at least four probes.

19. The apparatus of claim 18, wherein said probes are separated from adjacent probes by a distance of from about 2 inches to about 12 inches.

20. The apparatus of claim 13, wherein said fluid is water.
